(19) United States
(12) Patent Application Publication
(10) Pub. No.: US 2023/0175951 A1
(43) Pub. Date: Jun. 8, 2023

(54) Systems and Methods for Live Cell Imaging

(71) Applicants: Georgia Tech Research Corporation, Atlanta, GA (US); Emory University, Atlanta, GA (US)

(72) Inventors: Francisco E. Robles, Atlanta, GA (US); Wilbur Lam, Atlanta, GA (US); Ashkan Ojaghi, Atlanta, GA (US); Evelyn Williams, Atlanta, GA (US)

(21) Appl. No.: 18/063,531

(22) Filed: Dec. 8, 2022

Related U.S. Application Data
(60) Provisional application No. 63/287,260, filed on Dec. 8, 2021.

(51) Int. Cl. G01N 15/14

(52) U.S. Cl. CPC G01N 15/1475; G01N 15/1463

(57) ABSTRACT

An exemplary embodiment of the present disclosure provides a live cell imaging system, comprising a substrate, a UV light source, and a UV camera. The substrate can have a cavity configured to hold a sample. The sample can comprise one or more live cells. The substrate can be made, at least in part, out of polydimethylsiloxane (PDMS). The UV light source can be configured to direct UV light to the sample. The UV camera can be configured to take a UV image of the sample.

### CROSS-REFERENCE TO RELATED APPLICATIONS

This application claims the benefit of U.S. Provisional Application Ser. No. 63/287,260 filed on 8 Dec. 2021, which is incorporated herein by reference in its entirety as if fully set forth below.

### GOVERNMENT LICENSE RIGHTS

This invention was made with government support under Agreement No. 1752011, awarded by National Science Foundation. The government has certain rights in the invention.

### FIELD OF THE DISCLOSURE

The various embodiments of the present disclosure relate generally to microfluidic devices, and more particularly to systems and methods of using microfluidic devices to image live cells.

### BACKGROUND

Polydimethylsiloxane (PDMS) is a silicon-based organic polymer which is widely used in many industries for various applications including medical devices, cosmetics, lubrication, etc. PDMS is a versatile and low-cost polymer which possesses unique physical and chemical properties that makes it suitable for manufacturing PDMS-based devices and substrates. Apart from being non-toxic and inflammable, PDMS is optically clear and, when manufactured into a microfluidic device, can enable microscopic evaluation of many biological and physical phenomena under visible light. Despite these unique properties, the application of PDMS-based devices to study live cells under ultraviolet (UV) light via label and fixative-free UV microscopy has been largely neglected. PDMS is significantly less expensive than the conventional UV-transparent materials such as quartz or fused silica and can be readily manufactured in large quantities, making it a suitable alternative for many applications such as UV microscopy and spectroscopy of cells, tissues, and biomolecules.

PDMS has been widely used for manufacturing of microfluidic devices and flow channels used for study of various biological samples. Owing to the unique chemical and physical properties of PDMS along with its low cost and ease of manufacturing and modification, many different applications have been reported. However, conventional technologies have failed to consider the use of PDMS-based devices in the deep-UV wavelength range, particularly for the study of biological specimens such as live cells and tissue. An important feature for PDMS to be used for deep-UV microscopy is the material transmissivity (or lack of absorption) in this wavelength range which dictates the amount of light passing through the substrate during illumination and light detection. Previous studies have reported a moderate to low optical absorption for PDMS under ultraviolet (i.e., UV-A, UV-B, and UV-C) illumination which makes the PDMS-based microfluidic devices and substrates favorable to use along with UV-microscopy for label-free imaging of cells and tissues. But conventional technologies report only using PDMS to study samples with UV light where a polymer-based microfluidic device was designed for UV spectroscopy of liquid samples containing different components. However, no report exists for the use of PDMS based devices or substrates for deep-UV microscopy of live cells and tissue.

Accordingly, there is a need for PDMS based devices or substrates for deep-UV microscopy of live cells and tissue.

### BRIEF SUMMARY

An exemplary embodiment of the present disclosure provides a live cell imaging system, comprising a substrate, a UV light source, and a UV camera. The substrate can have a cavity configured to hold a sample. The sample can comprise one or more live cells. The substrate can be made, at least in part, out of polydimethylsiloxane (PDMS). The UV light source can be configured to direct UV light to the sample. The UV camera can be configured to take a UV image of the sample.

In any of the embodiments disclosed herein, the UV light source can be positioned such that at least a portion of the UV light is transmitted through the substrate.

In any of the embodiments disclosed herein, the UV light source can be positioned such that the at least a portion of the UV light is transmitted through the substrate proximate the cavity.

In any of the embodiments disclosed herein, the cavity of the substrate can be made, at least in part, of PDMS.

In any of the embodiments disclosed herein, the cavity of the substrate can be made entirely of PDMS.

In any of the embodiments disclosed herein, the system can further comprise a cover positioned above the cavity. The cover can be made, at least in part, out of PDMS.

In any of the embodiments disclosed herein, the cover can enclose the cavity.

In any of the embodiments disclosed herein, the system can further comprise an inlet and an outlet in fluid communication with the cavity. The inlet can be configured to introduce the sample to the cavity. The outlet can be configured to remove the sample from the cavity.

In any of the embodiments disclosed herein, the UV light can have a wavelength between 200 nm and 400 nm.

In any of the embodiments disclosed herein, the cavity can have an optical density of less than 4 for UV light having a wavelength from 200 nm to 400 nm.

Another embodiment of the present disclosure provides a method of imaging a sample comprising one or more live cells. The method can comprise: providing a substrate comprising a cavity containing the sample, the substrate made, at least in part, out of PDMS; directing UV light to the sample; and taking a UV image of the sample.

In any of the embodiments disclosed herein, the cavity can be made, at least in part, out of PDMS.

In any of the embodiments disclosed herein, the cavity can be made entirely out of PDMS.

In any of the embodiments disclosed herein, the method can further comprise introducing the sample to the cavity through an inlet in the substrate and removing the sample from the cavity through an outlet in the substrate.

In any of the embodiments disclosed herein, the UV image of the sample can be taken from UV light passing through the cavity, and the cavity can be made entirely of PDMS.

Another embodiment of the present disclosure provides a method of imaging one or more live cells. The method can comprise: providing a substrate comprising a cavity, the substrate made, at least in part, from PDMS; introducing a sample to the cavity, the sample comprising one or more live cells; directing UV light to the one or more cells, such that at least a portion of the UV light passes through the one or more cells and the substrate; collecting the at least a portion of the UV light that passes through the one or more cells and the substrate to create a UV image.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 provides a live cell imaging system, in accordance with an exemplary embodiment of the present disclosure.

FIG. 2A provides a plot of optical density spectra obtained in the deep-UV range from PDMS microfluidic devices with various thicknesses, wherein the inset shows a microfluidic device with 3.4 mm thickness, in accordance with exemplary embodiments of the present disclosure. FIGS. 2B and 2C provide images of USAF test targets using a 20×UV objective at 260 nm through a 1.7 mm thick layer of PDMS and a 3.4 mm thick layer of PDMS with glue, respectively.

FIG. 3 provides a plot of average pixel value obtained from images captured after different UV exposure times.

FIG. 4 provides photographs of deep-UV microscopy of whole blood using a microfluidic device, in accordance with an exemplary embodiment of the present disclosure.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

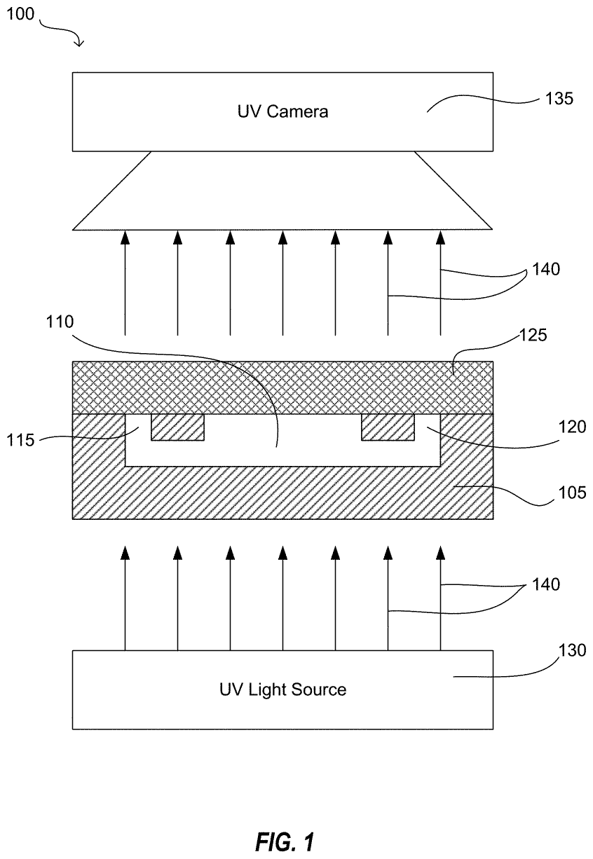

As shown in FIG. 1, an exemplary embodiment of the present disclosure provides a live cell imaging system 100. The system 100 can comprise a substrate 105 having a cavity 110 disposed therein. The cavity 110 can be any shape and can be configured to hold a biological sample (e.g., blood, tissue, etc.) (not shown) to be imaged. The substrate can be made, at least in part from PDMS. In some embodiments, the entirety of the substrate 105 can be made of PDMS. In some embodiments, only a portion of the substrate 105 can be made of PDMS. In some embodiments, it may be desirable for portions of the substrate proximate the sample, in which UV light will pass (as discussed below) to be made of PDMS. In some embodiments, the cavity 110 (i.e., the portion of the substrate that forms the cavity) can have an optical density of less than 4 for UV light having a wavelength from 200 nm to 400 nm, which can ensure UV light can sufficiently transmit through the substrate 105 proximate the cavity 110 and to the sample.

In some embodiments, the substrate 105 can further comprise an inlet 115 and outlet 120 for delivering and removing the biological sample from the cavity 110. Although the inlet 115 and outlet 120 are shown in FIG. 1 as extending to a top surface of the substrate 105, the disclosure is not so limited. Rather, a persons skilled in the art would appreciates, the inlet 115 and outlet 120 can be positioned at many locations about the substrate 105. For example, in some embodiments, the inlet 115 and outlet 120 can be positioned proximate a perimeter of the substrate 105.

In some embodiments, the system 100 can further comprise a cover 125 that can be disposed above the substrate 105, such that the cover 125 extends over at least a portion of the cavity 120, inlet 115, and/or outlet 120. In some embodiments, at least a portion, or the entirety, of the cover can be made of PDMS. In some embodiments, the cover 125 can be attached to the top surface of the substrate 105, using, for example, an adhesive.

In some embodiments, the system 100 can further comprise a UV light source 130. The UV light source 130 can be configured to direct UV light 140 to the sample. In some embodiments, as shown in FIG. 1, the UV light source 130 can be configured to direct UV light 140 to the sample from beneath the sample. In other embodiments, however, the UV light source 130 can be configured to direct UV light 140 to the sample from other directions, including, but not limited to, above the sample. In some embodiments, the UV light can have a wavelength between 200 nm and 400 nm.

In some embodiments, though not shown in FIG. 1, the UV light source 130 can comprise a bandpass filter configured to pass only UV light 140. For example, the light source 130 can comprise a broadband light source and a bandpass filter such that when the broadband light is incident on the bandpass filter, only a predetermined range of UV light can pass through the filter and is directed to the sample.

The system 100 can further comprise a UV camera 135 configured to take a UV image of the sample. For example, the UV camera 135 can pick up UV light that passes through the substrate and sample to produce a UV image of the sample. Although the UV light source 130 and UV camera 135 are positioned on opposite sides of the substrate/sample in FIG. 1, the disclosure is not so limited. For example, in some embodiments, the UV light source 130 and UV camera 135 can be positioned on the same side of the substrate/sample.

### Examples

The following examples further illustrate aspects of the present disclosure. However, they are in no way a limitation of the teachings or disclosure of the present disclosure as set forth herein.

Disclosed below is the use of PDMS-based devices and substrates for label-free microscopy of live, unlabeled cells and tissues. To this end, the optical absorption properties of PDMS in the blue to UV-C regions of the spectrum (c.a. 450-220 nm) are first characterized and show the utility of the PDMS substrate material for microscopy in this wavelength range. Next, the effects of UV exposure on the optical absorption properties of PDMS up to 30 minutes are investigated and show minimal absorption level change in PDMS substrates as a result of continuous UV exposure. Lastly, the capabilities of the embodiments disclosed herein via imaging of live and unfixed blood cells are shown which further signifies its unique implications in many areas of medicine and biology.

Materials and Methods

Microfluidic Device Design

A microfluidic device was initially designed for testing of this concept. This device comprised a single straight channel/cavity, ˜10 microns in height and ˜2 mm in width, with micro-posts evenly dispersed throughout the channel (222 μm and 66 μm spacing). Conventional photolithography was used for generation of the mold, as well as standard soft lithography for device fabrication. However, in this case, the device was specifically fabricated solely using PDMS—a thin layer of PDMS was used to seal the microchannels instead of a glass or quartz slide. This thin layer was ˜100 μm thick and was found to fall within the working distance of our UV objective (˜0.8 mm). Inlets and outlets were also punched in the thick, feature-containing layer using biopsy punches prior to bonding. Both plasma bonding and double-sided adhesives were used to bond the two PDMS layers together. After loading the device with whole blood, the device could be placed directly on the sample holder of our developed deep-UV microscopy system and imaged at various deep-UV wavelengths.

Deep-UV Microscopy Setup

The developed deep-UV microscopy system comprises an incoherent broadband laser-driven plasma light source (EQ-99X LDLS, Energetiq Technology). The output light from the broadband source was collected through an off-axis parabolic mirror (Newport Corporation) and relayed to the sample using a short-pass dichroic mirror (Thorlabs, N.J., USA). Multi-spectral imaging was performed using UV band-pass filters (Chroma Technology Corp, VT, USA) installed on a filter wheel, allowing acquisition of images at six wavelength regions centered at 220, 255, 280, 300, 340 and 415 nm. The light intensity on the sample plane was measured to be 0.14, 4.5, and 0.22 mW at 260, 280, and 300 nm wavelengths, respectively. For imaging, a 40× UV microscope objective (NA 0.5) (LMU-40X, Thorlabs) was used, by which an average spatial resolution of ˜280 nm was achieved. Images were then recorded using a UV sensitive CCD (pco.ultraviolet, PCO AG, Kelheim, Germany) camera (integration time=30-100 ms) while the sample was translated and adjusted for focusing via a three-axis high-precision motorized stage (MLS2031, Thorlabs). By raster scanning the sample, a series of UV images from a large area were acquired at each wavelength. Imaging time is approximately 3 minutes per wavelength for a 1×2 mm area on the sample (currently limited by the translation stage).

Results

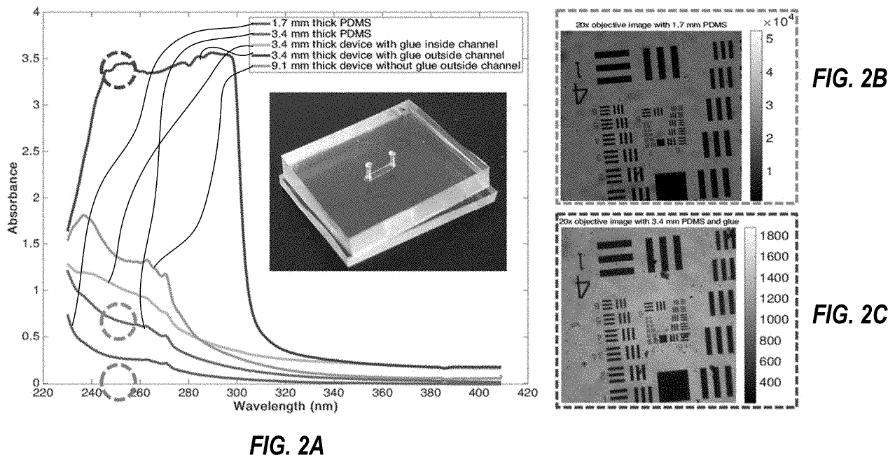

In order to assess the suitability of PDMS for microscopy in the deep-UV range, the optical absorption properties of PDMS layers with different thicknesses which correspond to different device designs were first determined. To this end, the absorption spectra were acquired using a slightly modified UV microscopy and spectroscopy setup. The main difference in the setup design for absorption measurements is that the UV-sensitive camera was replaced by an imaging spectrometer designed for use in the UV range. FIG. 2A demonstrates the results of our absorption spectra measurements of PDMS devices with different thicknesses where the bottom layer was attached to the top layer using both the double-sided adhesive and plasma bonding. The inset in FIG. 2A also depicts one of the designed devices.

The optical density spectra for PDMS were measured in the deep-UV range and is shown in FIG. 2A. The optical density spectra demonstrate a moderately low absorption for regions on the devices where the double-sided adhesive was not applied. However, the double-sided adhesive used during the manufacturing process is significantly more absorbing than PDMS in this wavelength range suggesting an advantage of plasma bonding. We also imaged a USAF test target using a 20×UV objective at 260 nm through a 1.7 mm thick layer of PDMS which also demonstrates high pixel values, suggesting a lower absorption level (depicted in FIG. 2B). On the other hand, the image obtained through the PDMS layers adhered together shows significantly lower pixel values confirming our higher absorption levels in the 240-300 nm wavelength range.

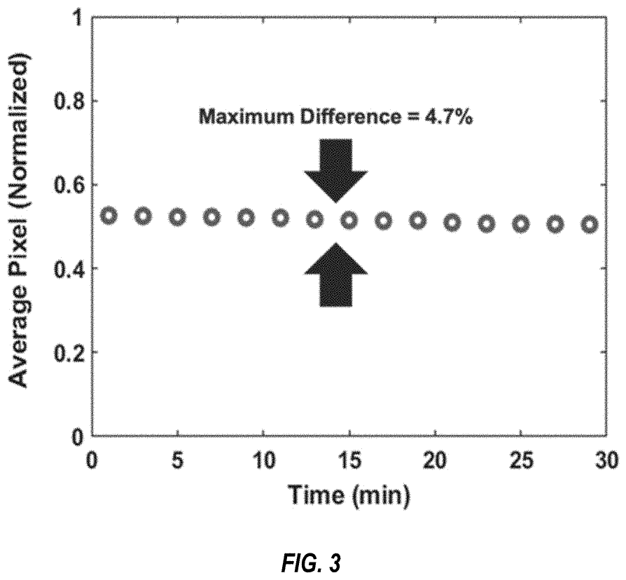

The optical absorption properties of PDMS do not change significantly with UV exposure over the time scales needed for wide area UV microscopy. In some materials, deep-UV light may can cause crosslinking of proteins, or other optical-altering behaviors, which may potentially change the optical properties of the material after prolonged UV exposure. To test the effect of UV light exposure on the optical absorption properties of PDMS during the experiments, a 3.4 mm thick PDMS layer was placed under 260 nm UV light for up to 30 minutes and acquired images at 2-minute time intervals. The average pixel values within the images are plotted in FIG. 3, showing a maximum difference of 4.7% between the average values. The observed trend does not show an increase in optical absorption (lower average pixel values suggest higher absorption). This finding is of significant importance since it clearly shows that the optical absorption of the PDMS-based microfluidic device does not significantly change within the time-scales relevant to these experiments.

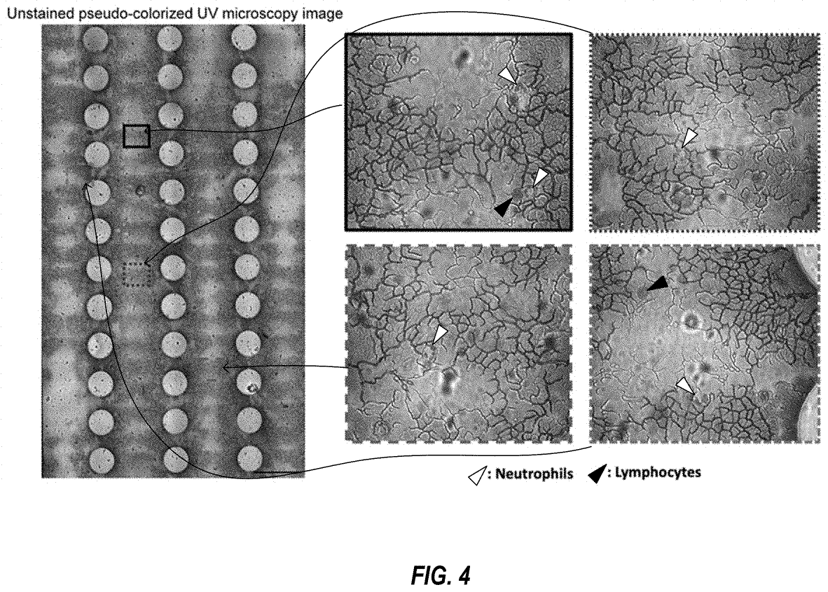

As the final demonstration of the capabilities of this innovation, live white blood cells (WBCs) in a whole blood sample collected from a healthy donor were imaged. To do this, an all-PDMS microfluidic device was used and loaded it with unfixed and unlabeled whole blood without any reagents or even anticoagulant. The developed platform formed a single-cell layer of whole blood, suitable for microscopy and cell visualization. By imaging the cells at the three deep-UV wavelengths, namely 255, 280, and 300 nm, and combining them based on a pseudo-colorization scheme, a series of pseudo-RGB UV images were obtained. FIG. 4 demonstrates the obtained wide-field UV image of whole blood within the PDMS microchannel along with the microposts used in the device design. As shown in the insets in FIG. 4, the WBCs were clearly recognizable via their unique nuclear morphologies and their unique violet color hue. The neutrophils and lymphocytes—two of the most abundant WBC subtypes in blood—are visualized and can be distinguished by their multi-lobular and large round nuclei, respectively. These results signify the unique potential of this innovation for low-cost and label-free live cell and tissue imaging, enabling study of biological specimens for applications in biology and medicine. This innovation also paves the way for development of point-of-care and clinical diagnostic devices.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. A live cell imaging system, comprising:
a substrate having a cavity configured to hold a sample, the sample comprising one or more live cells, the substrate made, at least in part, out of polydimethylsiloxane (PDMS);
a UV light source configured to direct UV light to the sample; and
a UV camera configured to take a UV image of the sample.

2. The live cell imaging system of claim 1, wherein the UV light source is positioned such that at least a portion of the UV light is transmitted through the substrate.

3. The live cell imaging system of claim 2, wherein the UV light source is positioned such that the at least a portion of the UV light is transmitted through the substrate proximate the cavity.

4. The live cell imaging system of claim 3, wherein the cavity of the substrate is made, at least in part, of PDMS.

5. The live cell imaging system of claim 4, wherein the cavity of the substrate is made entirely of PDMS.

6. The live cell imaging system of claim 1, further comprising a cover positioned above the cavity, the cover made, at least in part, out of PDMS.

7. The live cell imaging system of claim 6, wherein the cover encloses the cavity.

8. The live cell imaging system of claim 1, further comprising an inlet and an outlet in fluid communication with the cavity, the inlet configured to introduce the sample to the cavity, the outlet configured to remove the sample from the cavity.

9. The live cell imaging system of claim 1, wherein the UV light has a wavelength between 200 nm and 400 nm.

10. The live cell imaging system of claim 1, wherein the cavity has an optical density of less than 4 for UV light having a wavelength from 200 nm to 400 nm.

11. A method of imaging a sample comprising one or more live cells, the method comprising:
providing a substrate comprising a cavity containing the sample, the substrate made, at least in part, out of PDMS;
directing UV light to the sample; and
taking a UV image of the sample.

12. The method of claim 11, wherein the cavity is made, at least in part, out of PDMS.

13. The method of claim 11, wherein the cavity is made entirely out of PDMS.

14. The method of claim 11, wherein the substrate further comprises a cover positioned above the cavity, the cover made, at least in part, out of PDMS.

15. The method of claim 14, wherein the cover encloses the cavity.

16. The method of claim 11, further comprising introducing the sample to the cavity through an inlet in the substrate and removing the sample from the cavity through an outlet in the substrate.

17. The method of claim 11, wherein the UV light has a wavelength between 200 nm and 400 nm.

18. The method of claim 11, wherein the cavity has an optical density of less than 4 for UV light having a wavelength from 200 nm to 400 nm.

19. The method of claim 11, wherein the UV image of the sample is taken from UV light passing through the cavity, the cavity made entirely of PDMS.

20. A method of imaging one or more live cells, comprising:
providing a substrate comprising a cavity, the substrate made, at least in part, from PDMS;
introducing a sample to the cavity, the sample comprising one or more live cells;
directing UV light to the one or more cells, such that at least a portion of the UV light passes through the one or more cells and the substrate;
collecting the at least a portion of the UV light that passes through the one or more cells and the substrate to create a UV image.
